(19) United States
(12) Patent Application Publication
(10) Pub. No.: US 2017/0073959 A1
(43) Pub. Date: Mar. 16, 2017

(54) Anchoring System & Method of Use

(71) Applicants: Anthony Scarabelli, Ottawa (CA); Glen McDonald, Ottawa (CA)

(72) Inventors: Anthony Scarabelli, Ottawa (CA); Glen McDonald, Ottawa (CA)

(21) Appl. No.: 14/853,268

(22) Filed: Sep. 14, 2015

(51) Int. Cl. E04B 1/41; B23B 49/00; F16B 13/12

(52) U.S. Cl. CPC E04B 1/40; F16B 13/124; B23B 49/005; B23B 2270/34

(57) ABSTRACT

An anchoring system is disclosed, having an anchor where one end is plurality of prongs configured to expand and retain a substrate when engaged by a threaded rod pin and the other end is a partially threaded opening configured to engage the threaded rod pin. The threaded rod pin has a section of exterior threading that will engage with both the coupler and the anchor. A drill depth measuring guide having a hollow threaded holder to accept a dill bit. The holder has a setscrew to secure it to the drill bit and an exterior threaded cylinder to matingly engage a locking nut and a collar that can be threaded onto the holder at various locations to allow for different drill depths.

### BACKGROUND OF THE INVENTION

1. Field of Invention

Anchor systems are used to attach objects to structures or concrete.

2. Description of Related Art

There are two broad types of anchor systems for solid substrate construction materials: post-installed anchors and cast-in-place anchors (CIP). Post-installed anchors include Mechanical Expansion Anchors (MEA) and bonded anchors. MEA's are inserted in pre-drilled holes and are placed using a three-step process: (a) hammering the anchor into an opening in the substrate, (b) tightening a nut to engage an expansion mechanism, and (c) expanding the anchor into substrate. This process requires laborers to switch between tools when attempting to place an anchor, which is time inefficient and potentially hazardous under certain circumstances, for example, a worker may drop tools while switching. In addition a hammer is often used, which is potentially hazardous.

### SUMMARY OF THE INVENTION

The anchoring system streamlines the aforementioned process, such that only a power drill is required. The system is comprised of: a knurled drop-in anchor with prongs at one end, a machined threaded rod pin, a rod coupler with a stopper, a spline socket and a drill depth-measuring guide. Once the hole is drilled to its designated depth using a drill depth-measuring guide, the anchor is inserted. The threaded rod pin is then inserted into the aperture of the anchor and rotated inwardly. The coupler is then threaded onto the exposed end of the threaded rod pin. The spline socket then engages the coupler and is used to rotate the coupler-rod pin assembly into the drop-in anchor. As the threads of the rod pin engage with the threads of the anchor, the rod pin will continue into the anchor until it forces expansion of the distal end of the anchor to ensure that the anchor is secured into the substrate material. Finally, when the coupler-rod pin is released from the drill, the threaded portion of the rod remains exposed allowing for utilization of the anchor system. The anchor provides for options such has securing, hanging, stopping, supporting, and mounting items to the substrate.

In one embodiment of the invention, the drill depth-measuring guide with a pre-set depth is determined by the sleeve is used to create a hole of a desired depth and diameter. The anchor is then placed into the hole and the threaded rod pin is inserted into the exposed partially-threaded aperture of the anchor. A coupler is then threaded onto the exposed threaded rod pin. By rotating the coupler onto the threaded rod pin, the threaded rod pin will proceed into the anchor such that the threaded rod pin will apply a force to the interior sloped interior surface of the prongs. The force exerted by the threaded rod pin on the prongs will cause them to transfer that force through expansion onto the interior walls of the hole thereby locking the anchor into the hole.

In another embodiment the adjustable drill depth measuring guide is used to create a hole. The adjustable drill depth guide is first configured to the desired drill depth by inserting a drill bit through the interior aperture of the threaded holder and tightening the setscrew at the head of the threaded holder onto the shank of the drill bit. Then a locking nut is threaded onto the threaded holder followed by the collar. The collar is threaded onto the holder until the desired amount of drill bit tip is exposed. The locking nut is tightened against the collar, thus locking the collar in place. The hole is then drilled. The anchor is then placed into the hole and the threaded rod pin is inserted into the exposed partially-threaded aperture of the anchor. A coupler is then threaded onto the exposed threaded rod pin. By rotating the coupler onto the threaded rod pin, the threaded rod pin will proceed into the anchor such that the threaded rod pin will apply a force to the interior sloped interior surface of the prongs. The force exerted by the threaded rod pin on the prongs will cause them to transfer that force through expansion onto the interior walls of the hole thereby locking the anchor into the hole.

The present invention provides a cost-effective and efficient anchoring system and eliminates the need to have multiple tools such as a hammer, socket sets, and wrenches for the application of existing drop-in anchor systems presented in the prior art.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a side elevation view of a drop-in anchor grip apparatus, according to an embodiment of the present invention;

FIG. 2 is a side elevation view of the drop-in anchor grip apparatus, according to an embodiment of the present invention;

FIG. 3 is a side elevation view of a drill bit depth measurement guide, according to an embodiment of the present invention;

FIG. 4 is a side elevation view of a drill bit depth measurement guide, according to an embodiment of the present invention.

FIG. 5 is a perspective view of a spline socket, according to an embodiment of the present invention.

FIG. 6 is a side elevation view of a spline socket, according to an embodiment of the present invention.

### DETAILED DESCRIPTION OF PREFERRED EMBODIMENTS

Preferred embodiments of the present invention and their advantages may be understood by referring to FIGS. (1-6) wherein like reference numerals refer to like elements.

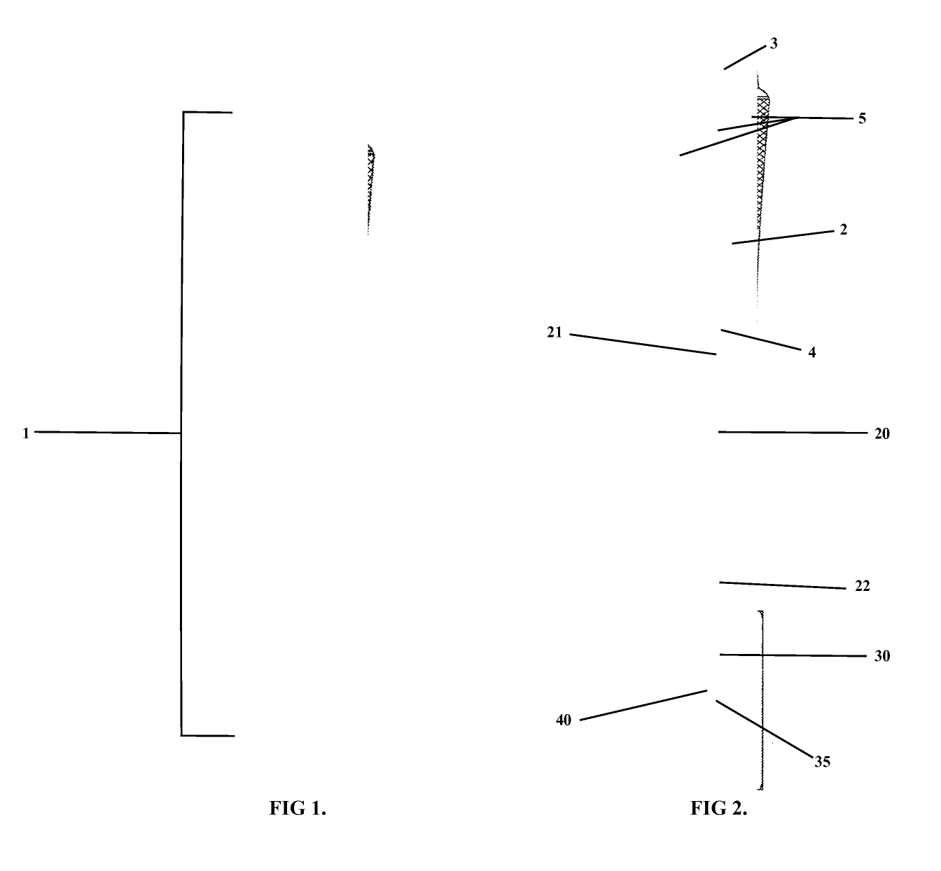

With reference to FIGS. 1-2, the anchoring apparatus 1 has a generally cylindrical anchor 2 having a first end 3 and a second end 4. The first end 3 of the anchor 2 has a plurality of prongs 5. In an embodiment, the prongs 5 are formed by a plurality of longitudinal cuts in the first end of the anchor 1, wherein a distal end of the prongs 5 is at the first end 3. In one embodiment, each of the prongs 5 have a knurled or textured exterior surface. The second end 4 of the anchor 2 has a partially threaded interior aperture extending therethrough adapted to receive a threaded rod pin 20. The distal end of each prong 5 is tapered for ease fitting in openings. FIG. 1 also shows a threaded rod pin 20, as a middle portion of the anchoring apparatus, having a first end 21 and second end 22. The second end 22 of the threaded rod pin 20 has a threaded exterior configured to matingly engage a coupler 30. The first end 21 of the threaded rod pin 20 is configured to penetrate the anchor 2 prior to the second threaded end 22 of the threaded rod pin 20. FIG. 1 also shows a coupler 30. In an embodiment the coupler 30 has a hexagonal exterior shape for use with a hexagonal socket (not shown). The coupler 30 has a threaded interior aperture therethrough, with a separator dividing the threading at each end, to accommodate the threaded rod pin 20 and a threaded workpiece at once. In an embodiment, the coupler 30 has a set pin 35 held in place by a retaining clip 40, and in another embodiment the aperture does not pass through, rather a separator (not shown) is present between the distal aperture and the proximal aperture.

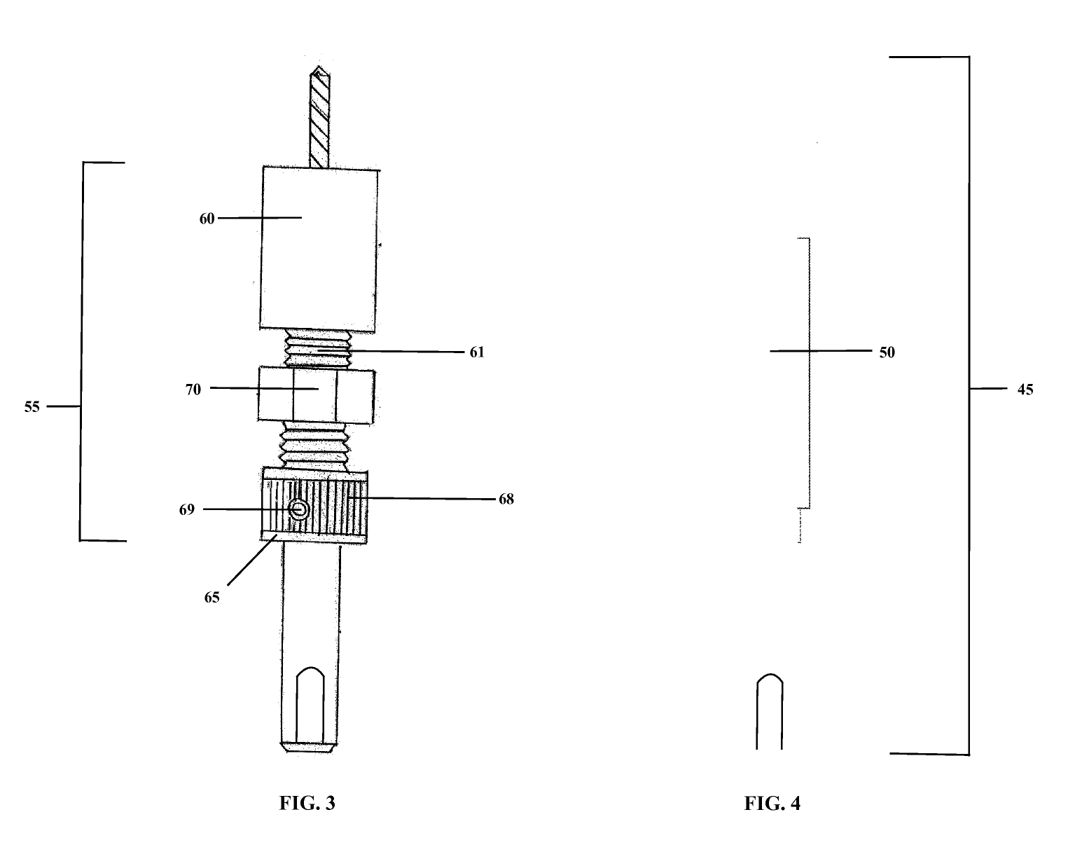

With reference to FIGS. 3-4 the anchoring apparatus has a drill depth-measuring guide 45. One embodiment of this drill depth-measuring guide is having a permanently integrated sleeve 50 exposing only a desired amount of the functional end of the drill bit, such that the drilled hole is drilled to a set depth. Another embodiment of the drill depth-measuring guide is the adjustable drill depth apparatus 55. The adjustable drill depth apparatus 55 has a collar 60 with a threaded aperture therethrough, configured to receive the externally-threaded cylinder 61 of the threaded holder 65. The collar 60 sits on the end of the threaded holder 65. The threaded holder 65 is made up of a hollow externally-threaded cylinder 61 that fits over a drill bit. The head 68 of the threaded holder 65 is affixed to the end of the cylinder 61, having a setscrew 69 therein for engaging and retaining a drill bit shank. Threaded onto the cylinder 61 and rotatably adjustable is a lock nut 70 with a threaded aperture configured to receive the cylinder 61 of the threaded holder 65, wherein the lock nut 70 may be tightened against the collar 60 to hold the collar in a given position on the cylinder 61.

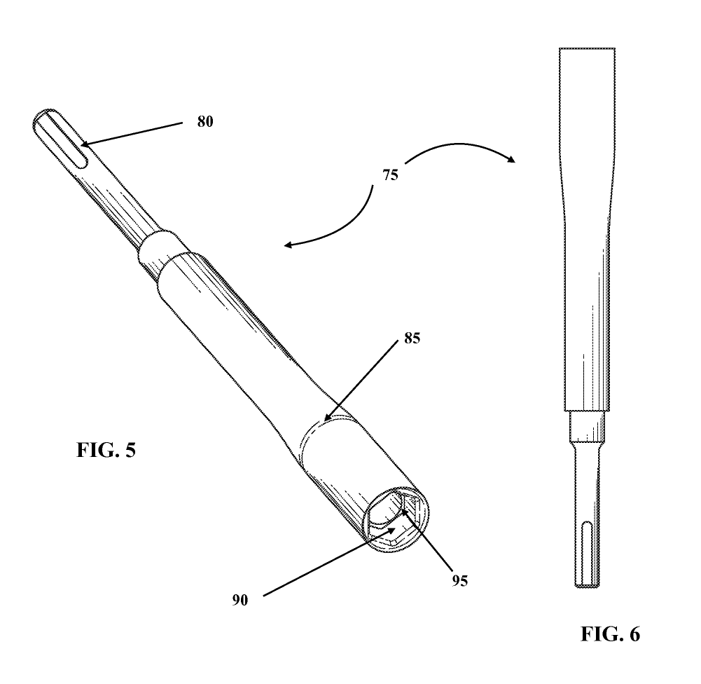

With reference to FIGS. 5-6 the spline socket 75 is used to rotate the coupler 30 and threaded rod pin 20. The spline socket 75 has a tail end 80 adapted to be received by a drill or similar tool (NOT SHOWN). The head 85 of the spline socket 75 has an opening defined by a plurality of surfaces 90. The number and characteristic of the surfaces 90 corresponds to the exterior surface of the coupler 30 near the interior portion of the surfaces 90 is a chamfered edge 95 to control the depth of the coupler 30 received by the spline socket 75.

In one embodiment of the present invention, the coupler 30 is permanently attached to the threaded rod pin 20 whereby the coupler 30—threaded rod pin 20 is used to engage the anchor 2 and then be removed from the anchor such that the coupler 30—threaded rod pin 20 can be used to engage multiple different anchors.

### In Use

In use, the drill depth measuring guide 45 is used in conjunction with a drilling tool to create a hole is a solid substrate to a desired depth and diameter. In one embodiment, the dimensions of the anchor are known and a user would select the drill depth guide with sleeve 50 that is permanently fixed at a set depth on a drill bit. A hole is then created in the substrate and an anchor 2 is placed therein with the prongs 5 being inserted into the hole. The threaded rod pin 20 is then inserted into the second end 4 of the anchor 2 such that the threaded end 22 contacts the interior partially threaded aperture of the anchor 2. The coupler 30 is then threaded onto the exposed second end 4 and rotated such that the coupler 30 matingly engages the threaded rod pin 20. The first end 21 of the threaded rod pin 20 will proceed to the first end 3 of the anchor 2 where it exert a force onto the sloped interior surface of the prongs thereby resulting in the transfer of force and outward expansion of the prongs 5 onto the adjacent walls of the hole. Such outward expansion will result in a frictional interaction between the knurled or textured exterior surface of the prongs with the walls of the hole. This interaction ultimately sets the anchoring apparatus 1 in a desired and static location.

In another embodiment, the adjustable drill depth apparatus is used to create a hole in the substrate by first sliding a drill bit through the threaded holder 65 and tightening the setscrew onto the drill bit. Then, threading the locking nut 70 onto the externally-threaded cylinder 61. The collar 60 is then threaded onto the externally-threaded cylinder 61 of the threaded holder 65 until the desired drill depth was exposed. Finally, the locking nut 70 is tightened against the collar such that it locks the collar in place. The anchor 2 is then oriented such that the first end 3 leads as the entire anchor 2 is placed therein. Next, the threaded rod pin 20 is placed into the second end 4 of the anchor 2. The coupler 30 is then rotated onto the second end 22 of the threaded rod pin 20 such that the threaded aperture of the coupler 30 matingly engages the threaded rod pin 20. After the coupler 30 has engaged the threaded rod pin 20, the coupler 30 is continually rotated such that the first end 21 of the threaded rod pin matingly engages the second end 4 of the anchor 2. The first end 21 of the threaded rod pin 20 will proceed to the first end 3 of the anchor 2 where it exert a force onto the sloped interior surface of the prongs 5 thereby resulting in the transfer of force and outward expansion of the prongs 5 onto the adjacent walls of the hole. Such outward expansion will result in a frictional interaction between the knurled or textured exterior surface of the prongs with the walls of the hole. This interaction ultimately sets the anchoring apparatus 1 in a desired and static location.

In another embodiment, the spline socket 75 is used to rotate the coupler 30. The tail end 80 of the spline socket is inserted into a drill. The head 85 of the spline socket is then positioned to address the coupler 30. The couple 30 enters the head 85 of the spline socket 75. The spline socket 75 is then rotated such that the interior surfaces 90 engage the coupler 30 and transfer the rotational forces from the drill through the spline socket 75 to the coupler 30. The spline socket 75 continuously rotates the coupler 30 and threaded rod pin 20 into the anchor 2 until the prongs 5 are sufficiently engaged with the hole.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An anchoring system comprising:
a. a generally cylindrical anchor having an aperture therethrough, comprising a distal end having a plurality of prongs wherein the prongs are configured to expand outward and a proximal end having threading on a wall of the aperture;
b. a hexagonal coupler having a threaded opening at a distal and proximal end;
c. a threaded rod pin having a threaded proximal end adapted to engage the threaded proximal end of the anchor as well as the threaded proximal end of the coupler and a protruding distal end configured to penetrate between the prongs.

2. The anchoring system of claim 1 wherein the prongs are defined by longitudinal cuts in the distal end of the anchor, and the prongs are configured to expand outward when penetrated by the protruding end of the threaded rod pin.

3. The anchoring system of claim 1 further comprising a spline socket wherein the spline socket is configured to rotate the coupler.

4. The anchoring system of claim 1 wherein the plurality of prongs has a textured exterior surface.

5. The anchoring system of claim 1 wherein the coupler further comprises a threaded opening at a proximal end to receive a threaded rod.

6. The anchoring system of claim 4 further comprising a separator that bisects the proximal and distal ends of the coupler.

7. The anchoring system of claim 1 wherein the protruding distal end of the threaded rod pin is smooth.

8. The anchoring system of claim 1 wherein the anchor has four prongs.

9. A drill depth guide apparatus comprising:
a. a cylindrical holder having an aperture therethrough, the holder comprising a first end and a second end wherein a surface of the holder is threaded;
b. a collar comprising a threaded aperture adapted to fit over the second end of the holder;
c. a collar lock comprising a threaded aperture adapted to matingly engage with the thread holder, wherein the nut is configured to lock the collar on the holder.

10. The depth guide apparatus of claim 6 wherein the holder further comprises a head having the set screw at the first end configured to retain the holder on a drill shank

11. The depth guide apparatus of claim 6 further comprising as externally-threaded cylinder adapted to matingly engage with the collar.

12. A method for installing an anchoring system comprising the steps of:
a. drilling a hole into a substrate;
b. inserting an anchor having expansion prongs at a distal end, wherein the anchor is inserted distal-end first
c. inserting a threaded rod pin into the proximal end of the anchor
d. affixing a coupler to the rod pin, wherein the coupler is rotated to rotate the rod pin
d. rotating the rod pin into the anchor such that the threaded rod pin penetrates the anchor expanding the prongs outward thereby engaging the substrate

13. The method of claim 9 further comprising the step of selecting a drill depth measuring guide.

14. The method of claim 10 further comprising the steps of threading a collar on the drill depth guide apparatus to adjust a drill depth and fixing the collar by tightening a nut against the collar.

15. The method of claim 12 wherein once threaded the coupler protrudes from the substrate.

16. The method of claim 12 wherein a spline socket is used to rotate the coupler onto the threaded rod pin.

17. The method of claim 13 further comprising threading a threaded rod into the coupler.
